(19) United States
(12) Patent Application Publication
(10) Pub. No.: US 2021/0262483 A1
(43) Pub. Date: Aug. 26, 2021

(54) Compressor

(71) Applicant: BMTS Technology GmbH & Co. KG, Stuttgart (DE)

(72) Inventor: Simon Henzler, Ostfildern (DE)

(21) Appl. No.: 17/159,234

(22) Filed: Jan. 27, 2021

(30) Foreign Application Priority Data
Feb. 24, 2020 (EP) 20 159 077.5

(51) Int. Cl. F04D 29/28; F04D 29/42; F04D 29/66; F04D 29/056; F04D 29/08; F04D 17/10

(52) U.S. Cl. CPC F04D 29/284; F04D 29/4206; F04D 17/10; F04D 29/056; F04D 29/083; F04D 29/663

(57) ABSTRACT

The invention relates to a compressor, in particular a gas compressor, for instance for a turbocharger, for compressing a gaseous fluid, having a compressor housing (40) in which a compressor wheel (41) is rotatably arranged, wherein the compressor housing (40) has a gas intake manifold (43), via which gas can be fed to the compressor wheel (41), a compressor duct (42) being provided, via which the compressed gas can be discharged from the compressor wheel (41), an adjustment device (60) being arranged in the area of the gas intake manifold (43), wherein the adjustment device (60) has orifice elements (70), which can be adjusted linearly between a closed position and an open position, and by means of which the opening cross-section of the gas intake manifold (43) in a duct area can be varied in order to form a minimum opening cross-section (Ömin) in the closed position and a maximum opening cross-section (Ömax) in the open position, wherein in each case two adjacent orifice elements (70) have sealing segments (73.1, 76.1) which, in the closed position, face each other, in particular rest against each other. To be able to reduce the noise emissions in such a compressor in a simple and effective manner, provision is made according to the invention that the orifice elements (70) can be adjusted into a retracted operating position, in which body areas of the orifice elements (70) at least in some areas delimit a recess, in particular a circumferential groove, in the gas intake manifold (43) to form a resonator, in particular a Helmholtz resonator, and wherein provision may in particular be made that the orifice elements (70) can be adjusted, preferably continuously, between several retracted operating positions.

### BACKGROUND OF THE INVENTION

### 1. Field of the Invention

The invention relates to a compressor, for compressing a gaseous fluid, having a compressor housing, in which a compressor wheel is rotatably arranged, wherein the compressor housing has a gas intake manifold, which can be used to fed gas to the compressor wheel, wherein a compressor duct is provided, which can be used to discharge the compressed gas from the compressor wheel, wherein an adjustment device is arranged in the area of the gas intake manifold, wherein the adjustment device has orifice elements, which can be adjusted linearly between a closed position and an open position and which can be used to change the opening cross-section of the gas intake manifold in a duct area to form a minimum opening cross-section in the closed position and a maximum opening cross-section in the open position, wherein in each case two adjacent orifice elements have sealing segments, which face each other in the closed position, in particular rest against each other, to form an orifice area.

Such compressors form in particular gas compressors, for instance for a turbocharger, an electric compressor or the like.

### 2. Description of the Prior Art

A compressor for a turbocharger is known from DE 10 2018 202 066 A1 (US 2019249611). Turbochargers are used to compress charge air in a combustion engine. A compressor wheel is used, which draws in charge air in a gas intake manifold and compresses it. Compressor wheels used in compressors are usually designed for a certain operating range, which is based on a mass flow of supplied air varying within certain limits. However, during operation of the combustion engine, the amount of required charge air can vary greatly. To be able to adapt the surge line and the choke line of the compressor to the varying charge air requirements, DE 10 2018 202 066 A1 (US 2019249611) proposes adapting the opening cross-section of the gas intake manifold. An adjustment device is used for this purpose. The adjustment device has a large number of orifice elements. The orifice elements can be adjusted between an open position and a closed position. In the open position, the orifice elements open the maximum opening cross-section of the gas intake manifold. In a closed position, the orifice elements form an orifice having an opening cross-section, wherein this opening cross-section is smaller than the maximum opening cross-section. DE 10 2018 202 066 A1 (US 2019249611) proposes to keep the orifice elements linearly adjustable on a bearing ring of the adjustment device. In this way, the orifice elements can be moved linearly back and forth between the open position and the closed position. The adjacent orifice elements form sealing segments perpendicular to the orifice plane, which slide past each other during the adjustment motion of the orifice elements. In this way, it is guaranteed that in the closed position and in intermediate positions between the open position and the closed position no or only little leak air flows between the orifice elements.

Compressors known from WO 2018/106620 A1 (US 2020011196) and EP 3 236 077 A1 (US 2017298953) operate on the same basic principle as the compressor described above of the DE 10 2018 202 066 A1 (US 2019249611). Instead of linearly movable orifice elements, these documents suggest that the orifice elements should be swivel mounted at a bearing ring. Accordingly, the orifice elements can be swiveled from an open to a closed position and back. In the closed position, the orifice elements rest against each other in the area of sealing segments. When the orifice elements are turned from the closed position to the open position, the space between the sealing segments increases continuously. This results in enlarging gaps, through which “leak air” flows in the intermediate positions and turbulent flows can occur. This reduces the efficiency of the adjustment device, i.e., for a closed adjustment device, the compressor map is not shifted as much towards smaller mass flows of intake air. In addition, such compressors can cause annoying noise emissions.

For turbochargers, especially exhaust-driven turbochargers, it is known that annoying charge-exchange noise can occur during charge exchange. These charge-exchange noises comprise the noise components emitted by the intake and exhaust systems. They can be divided into noise components caused by pulsating flow resulting from the periodic work process of the combustion engine and noise components caused by flow noise. The flow noise is particularly important at low speeds and high loads, because a correspondingly large volume throughput causes major excitation. With increasing speeds, mechanical noises then increasingly prevail. Silencers on the exhaust side are usually used to dampen the pulsation noise. For the abatement of flow noise, it is known from the state of the art to provide grooves in the flow wall of a flow channel, as shown in US 930 3561 B1

The invention addresses the problem of providing a compressor of the type mentioned at the beginning, which compressor can be used to reduce the noise emissions in a simple manner.

### SUMMARY OF THE INVENTION

This problem is solved by the features of the claims. Accordingly, provision is made that the orifice elements can be adjusted into a retracted operating position, in which body areas of the orifice elements at least in some areas delimit a recess, in particular a circumferential groove, in the gas intake manifold to form a resonator, in particular a Helmholtz resonator. In particular, provision may be made that the orifice elements can be adjusted, preferably continuously, between several retracted operating positions.

Accordingly, the recess forms a cavity across which the volume flow passes. This cavity contains a volume of gas, which is excited to oscillate by the gas flowing past. This generates a sound wave, which influences, in particular cancels out, annoying frequencies of the sound spectrum emitted by the gas flowing past.

As the recess in the gas intake manifold system is limited by one or more orifice elements, this recess can be integrated into the overall design in a technically simple manner without a significant additional technical effort.

In particular, the orifice position in the open position can be adjusted such that a certain resonance volume is limited by the recess, which can then be used to influence a specific interference frequency.

Furthermore, it is conceivable that the orifice elements can be adjusted between several retracted operating positions. In the individual retracted positions, the orifice elements then limit the recess, at least in some areas. In this way, the dimensions of the recess can be altered. The volume of gas that can be absorbed in the recess changes accordingly. This can also change the sound frequency emitted by the resonator during operation. Accordingly, the resonator can be set for different operating states of the compressor to influence certain frequencies in these operating states.

The resonator is designed as a circumferential groove. It has been shown that a particularly effective influence on the interference frequency can be achieved in this way.

Further, the resonator is also preferably designed as a Helmholtz resonator, such that a specific frequency can be set very precisely, which can be used to eliminate an interference frequency.

For instance, provision may also be made that the opening cross-section, which forms the transition from the volume enclosed by the recess to the gas intake manifold, has a smaller cross-section than the resonator volume downstream thereof.

It may be preferable that the recess is limited laterally by body areas of the gas intake manifold. One or more orifice elements can then form a boundary between the lateral body areas of the recess at the bottom. For instance, a groove may be formed, which is square in cross-section, in particular rectangular or square or largely rectangular or largely square. The side walls of the groove can be formed by the gas intake manifold, for instance. The floor located between the side walls can then be formed by one or more orifice elements. The side walls of the groove do not have to be parallel to each other. Rather, they can also be set at an angle to each other or have other varying cross-sectional characteristics. The floor formed by the panel(s) does not have to be rectilinear, either. For instance, it can also be convex or concave at least in some areas or in some other way, for instance undulatory.

It is also conceivable that a spacing area, in particular a gap area, forms between the body area of the orifice element, which delimits the recess, and the adjoining area(s) of the recess. This results in a further volume downstream of the recess, e.g., to the side of the retracted orifice element or behind the retracted orifice element, which further volume can also be used as a resonance volume.

It is also conceivable, of course, that the orifice elements in the retracted position are closely assigned to the other areas of the recess, such that the volume of the recess is as sealed off as possible. In most cases, there does not have to be a sealing end provided, in the majority of the cases it is sufficient for the body area of the orifice element to be connected to the other areas of the recess, leaving a narrow gap.

According to a preferred variant of the invention, provision made be made that the sealing segments of the linearly movable orifice elements face each other in the closed position, in particular rest against each other, and are arranged at a distance from each other in the open position and/or in an intermediate position between the open position and the closed position.

In the closed position, the sealing segments of the adjacent orifice elements can be brought together to form a seal. This ensures that in the closed position no or only negligible amounts of air flow between the sealing segments. According to the invention, the orifice elements can be moved linearly. When the orifice elements are moved from their closed position to the open position, according to the invention this is done in such a way that the sealing segments are slightly spaced apart from each other. Thus, the adjustment motion is not impeded by sealing segments sliding past each other. This results in a reliably working adjustment device, which in particular also prevents a blockage due to the orifice elements being jammed. In particular, in this way, simpler bearing elements can be implemented for the orifice elements. As the orifice elements can be moved linearly, as shown in the illustration, the spacing of the sealing segments along the entire adjustment travel when moving from the closing motion to the opening motion can be minimized. This guarantees that even in the intermediate positions between the open and closed position, there is at most only a small amount of “leak air flow” between the sealing segments. This permits an efficiency-optimized design of the compressor. In particular, the surge line can be raised effectively for low mass flows of intake air.

According to a preferred design variant of the invention, provision may be made that the sealing segments are aligned in parallel to each other during the adjustment travel between the open and closed position. Designing the orifice elements is then easy. It is preferable for the sealing segments to be aligned in parallel to each other in every intermediate position on the adjustment travel between the open and closed position. In this way, in particular in every intermediate position constant or approximately constant gap widths can be achieved.

According to a conceivable alternative embodiment of the invention, provision may in particular be made that the orifice elements have two linearly extending sealing segments, which are arranged at an angle from each other, wherein one sealing segment rests against an assigned sealing segment of a first adjacent orifice element and the further sealing segment rests against an assigned sealing segment of a second adjacent orifice element.

A compressor according to the invention may also be such that a first linear sealing segment of the orifice element is set at an angle to the direction of motion of the orifice element, and that this angle is smaller than X, wherein: “X=360°/(number of orifice elements)” and/or X is the angle formed by the two linear sealing segments of the orifice element. This simple measure ensures that the sealing segments of adjacent orifice elements can be pass each other in the closed position and that they are then immediately spaced apart when moving from the closed position towards the open position. Accordingly, only minimal forces are required to override the closed position.

According to a variant of the invention, minimum gap distances can be achieved in the intermediate positions in that the difference between half the angle X and the angle β formed between a perpendicular to the sealing segment of the orifice element and the direction of motion of the orifice element is smaller than 10°, such that the formula

“(0.5*X−β)<10°” applies.

It may be particularly preferred that the difference between half the angle X and the angle β formed between a perpendicular to the sealing segment of the orifice element and the direction of motion of the orifice element is smaller than 5°, such that the formula

“(0.5*X−β)<5°” applies.

In this case, the leakage flow between the sealing segments of the orifice elements is minimized to an acceptable level for turbocharger applications.

For particularly demanding turbocharger systems, provision may be made that the difference between half the angle X and the angle β formed between a perpendicular to the sealing segment of the orifice element and the direction of motion of the orifice element is smaller than 2°, such that the formula

“(0.5*X−β)<2°” applies.

For such highly demanding turbocharger systems, provision may in particular also be made that in the intermediate positions between the open position and the closed position and in the open position, the sealing segments are not more than 1 mm apart, preferably not more than 0.3 mm apart.

A further preferred variant of invention may be such that at least one orifice element of at least two adjacent orifice elements has an overlap segment in the area of at least one of its sealing segments, the projection of which overlap segment in the direction of flow in the gas intake manifold, preferably in the direction of the axis of rotation of the compressor wheel, at least partially covers the sealing segment of the adjacent orifice element in the closed position and in at least one intermediate position between the open position and the closed position. This guarantees a sealing effect even if the sealing segments are slightly spaced apart in the intermediate position, and the adjustment device can be reliably operated. Preferably, overlap should be ensured in every intermediate position.

In accordance with the invention, provision may also be made that at least one of the orifice elements has an overlap segment at both sealing segments, wherein one overlap segment overlaps the adjacent first orifice element at the front in the flow direction of the gas intake manifold and the second overlap segment overlaps the adjacent second orifice element also at the front in the flow direction of the gas intake manifold. This has the advantage of simplified manufacturability, as both overlap segments for the relevant orifice element can be embossed from the same side. In this case, however, two types of differently embossed orifice elements are required for one adjustment device, which increases the number of parts required. It also restricts the design in such a way that only an even number of orifice elements can be used.

In accordance with the invention, provision may also be made that at least one of the orifice elements has an overlap segment at both sealing segments, wherein one overlap segment overlaps the adjacent first orifice element at the front in the flow direction of the gas intake manifold and the second overlap segment overlaps the adjacent second orifice element at the rear in the flow direction of the gas intake manifold. This facilitates the design of the orifice elements. In particular, it will then also be possible to design the orifice elements in the same way. This results in a reduction in the number of parts and the number of orifice elements can be varied as required.

A compressor according to the invention may also be characterized in that the sealing segments of at least two adjacent orifice elements have overlap segments, the projections of which at least partially overlap in the direction of the flow direction in the gas intake manifold, preferably in the direction of the axis of rotation of the compressor wheel. In this way, for instance, labyrinth-like seals can be implemented. In particular, structures can be created, in which overlap segments are provided on the adjacent orifice elements, which mesh when they are closed and/or in an intermediate position.

It is also conceivable that the overlap segment(s) of at least two adjacent orifice elements lie(s) in a sealing manner on the adjacent orifice element(s) in the closed position and/or in at least one intermediate position. For this purpose, provision may in particular be made that the overlap segments are designed as a seal attachment that can be bent relative to a base body of the orifice element.

During operation there is a differential pressure between the upstream and downstream side of the adjustment device.

The design of the sealing lugs can, for instance, be such that the differential pressure causes the sealing lugs to bend and lie against the adjacent orifice element in a sealing manner. The seal attachment of an orifice element rests at least partially on an adjacent orifice element in any position of the orifice elements, such that the adjacent orifice element can always slide downstream of the seal attachment and jamming is prevented.

In addition or alternatively, provision may also be made that the adjacent orifice elements can be offset from each other in order to bring the overlap segments into sealing contact with the adjacent orifice element(s). For this purpose, provision may in particular be made that the bearing of the sealing elements permits the orifice elements to be adjusted in the flow direction of the gas intake manifold. This results in a play, which can be used to bring the sealing attachments into contact with each other because of the differential pressure described.

In particular, provision may also be made to reduce the cost of parts and assembly, in that the at least one overlap segment is integrally molded onto the orifice element. For instance, provision may be made to design the orifice elements and the overlap segment as one integral plastic part. In particular, a plastic injection molded part is easy to manufacture. Alternatively, it is conceivable that the orifice elements are manufactured as punched and bent parts from a sheet metal blank. The overlap segment(s) can then be easily embossed.

A further preferred design of the orifice elements provides that the facing overlap segments of two adjacent orifice elements are designed differently, such that in the closed position the sealing surface of the overlap segment of the first orifice element rests against the sealing surface of the second orifice element and the sealing surface of the overlap segment of the second orifice element forms a gap with the sealing surface of the first orifice element.

A particularly preferred design of the invention provides that the adjustment device has a bearing unit, which is preferably designed in the form of a bearing ring, in that the bearing unit has a plurality of slide guides having linear guide areas, on each of which an orifice element is movably installed by means of a guide element, and in that the bearing unit preferably forms guide surfaces, on which the orifice elements are supported by slideways.

Furthermore, it is conceivable to design the compressor in such a way that the adjustment device has an actuator, which is preferably designed in the form of a shaft collar, that the adjustment device has an actuating device, which can be used to adjust, in particular rotate, the actuator, that the actuator has slide guides having linear guide areas, on each of which an orifice element is movably installed by means of a guide element, and that preferably the actuator forms guide surfaces, on which the orifice elements are supported by slideways. In this way, a very simple designed adjustment device can be implemented.

If provision is made that delimiting elements, which are of concave design, adjoin the sealing segments of the orifice elements, and that the delimiting elements form an at least approximately circular orifice opening in the closed state of the orifice elements, then the opening cross-section defined by the orifice can be at least approximated to a circular opening in the closed state. This results in improved flow behavior while preventing turbulent flows.

In particular, it may be preferable to limit the motion of the orifice elements from the open position to the closed position by means of a stop which, in the closed position, rests against a counterstop. This prevents the orifice elements from jamming in the closed position. Preferably, the stop and the counter-stop are formed by the adjacent orifice elements themselves. In particular, the stop and/or the counterstop can be designed integrally with the orifice elements.

In this respect, a design, in which an adjacent orifice element has a counter-stop, for instance in the form of a recess, is particularly suitable. The stop, for instance a body edge, of the orifice element can strike against such a counter-stop at an obtuse angle to its direction of motion in the closed position.

According to the invention, provision may in particular be made that a signal transducer is used to detect the interference frequency. An evaluation unit is used to evaluate the interference frequency. The determined interference frequency is evaluated in the evaluation device, for instance by comparison to a correlation stored in a database or by a functional correlation or by comparison to a map, and the required groove depth is determined, which is necessary to eliminate or influence the interference frequency. The evaluation unit is connected to an actuator via a control device. The actuator can then be used to position the orifice elements such that the desired groove depth or nearly the desired groove depth is set.

It is also conceivable that the retracted position of the orifice elements can be adjusted depending on the operating state of the engine/turbocharger, for instance to vary the groove depth, in order to filter any resulting noise. Accordingly, the positions of the orifice elements in their retracted positions can be correlated with, for instance, engine speeds, turbocharger speeds, mass flows routed through the turbocharger, etc. in a in a memory unit. An actuator can retrieve these correlations and control a control device. The control device then sets the groove to the desired depths.

Accordingly, when the orifice elements are retracted, the adjustment device simultaneously forms at least part of the resonator, in particular the Helmholtz resonator. This reduces in particular the cost of parts and assembly for the compressor.

It may also be particularly preferable that the retracted position of the orifice elements can be adjusted depending on the operating state of the engine and/or turbocharger in order to filter any resulting noise.

### BRIEF DESCRIPTION OF THE DRAWINGS

The invention is explained in greater detail below based on an exemplary embodiment shown in the drawings. In the Figures:

FIG. 1 shows a side view and a full section of an exhaust gas turbocharger,

FIG. 2 shows a perspective and in partial section of a unit of the exhaust gas turbocharger as shown in FIG. 1,

FIG. 3 shows a full section of the unit of FIG. 2,

FIG. 4 shows a partial representation and front view of an adjustment device,

FIGS. 5 and 6 show two different perspective representations of an orifice element,

FIG. 7 to FIG. 9 show front views of different operating positions of the adjustment device,

FIG. 10 shows a partial representation and front view of an alternative design variant of an adjustment device,

FIG. 10a shows the design variant according to FIG. 10 along the course of the cut marked Xa-Xa in FIG. 10,

FIG. 11 shows a partial representation and front view of a further alternative design variant of an adjustment device,

FIG. 11a shows the design variant according to FIG. 11 along the course of the cut marked XIa-XIa in FIG. 11,

FIG. 12 shows a partial representation and front view of a further alternative design variant of an adjustment device,

FIG. 12a shows the design variant according to FIG. 12 along the course of the cut marked XIIa-XIIa in FIG. 12,

FIGS. 13 and 14 show a partial view and partial representation of a further alternative of an adjustment device and

FIG. 15 shows a schematic partial representation a section of a further variant of the invention.

### DETAILED DESCRIPTION

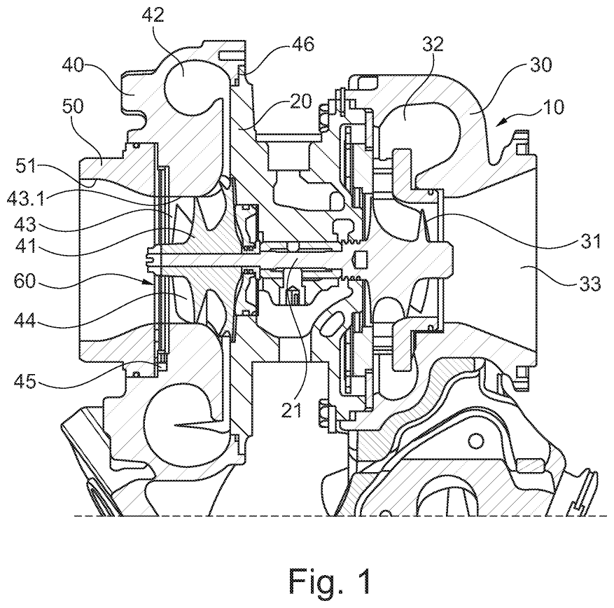

FIG. 1 shows a turbocharger 10, namely an exhaust gas turbocharger, as typically used in vehicles equipped with combustion engines. The turbocharger 10 has a housing 20. A shaft 21 is rotatably mounted in this housing 20. There is a compressor wheel 41 at one end and of the shaft 21 and a turbine 31 at the other end.

The turbine 31 is housed in a turbine housing 30. The turbine housing 31 forms a spiral duct 32. It is formed like a channel. The exhaust gas flow from the combustion engine can be guided into the turbine 31 via the exhaust gas intake manifold and the spiral duct 32. The turbine housing 30 also forms an exhaust outlet 33. As the diagram shows, the exhaust gas from turbine 31 enters radially to the direction of rotation. In the exhaust gas outlet 33 the exhaust gas leaves the turbine housing 30 in the direction of the axis of rotation.

The compressor wheel 41 is surrounded by a compressor housing 40. A compressor duct 42 is arranged in the compressor housing 40. Furthermore, the compressor housing 40 has a gas intake manifold 43. The gas intake manifold 43 forms a duct wall 43.1. The gas to be compressed (e.g., air) can be routed axially to the compressor wheel 41 in the direction of its axis of rotation through the gas intake manifold 43.

As can be seen from the drawing, the gas intake manifold 43 may, for instance, also be formed at least partially by a housing part 50 of the compressor housing 40, wherein the housing part 50 is connected to the base body of the compressor housing 40. FIG. 1 shows that the housing part 50 has a flow guide 51, which transitions into the wall 43.1 as part of the gas intake manifold 43.

As FIG. 1 shows, the wall 43.1 of the gas intake manifold 43 is adapted to the contour of the compressor blades 44, resulting in an efficiency-optimized design.

FIG. 1 shows that an adjustment device 60 is held in the area between the housing part 50 and the base body of the compressor housing 40.

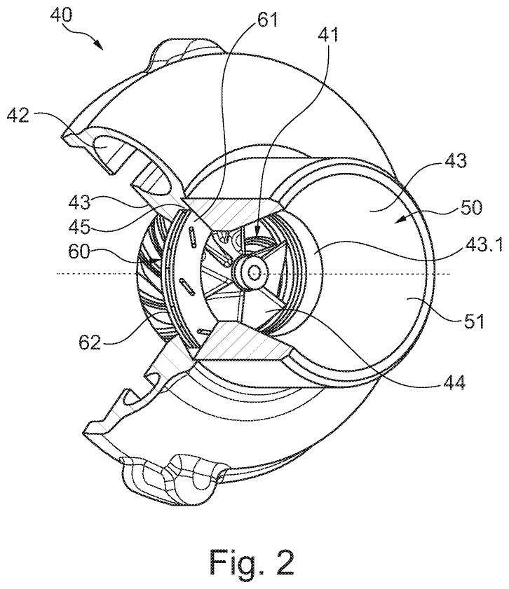

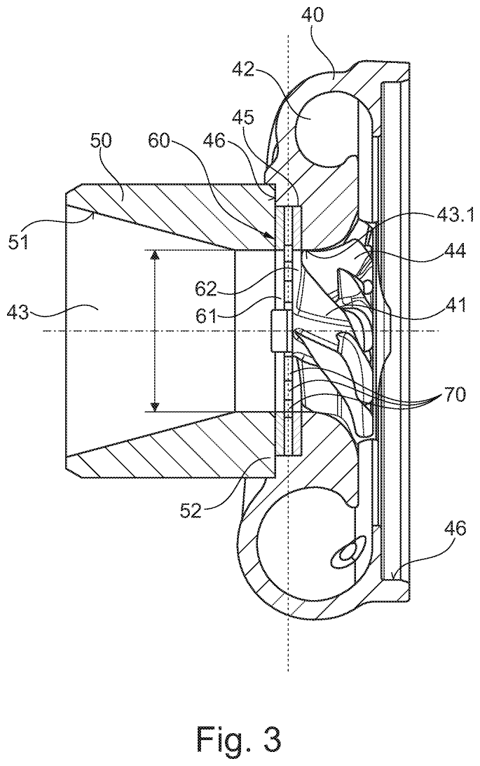

FIGS. 2 and 3 show the design of the adjustment device 60 in more detail. These diagrams show that the adjustment device 60 can have a bearing unit 61. The bearing unit 61 can for instance, as shown here, be formed by an annular component, wherein in particular the bearing unit 61 is manufactured from a flat component, e.g., a sheet metal blank or a plastic part. The bearing unit 61 can also be part of the housing part 50. Preferably, however, it is designed as a separate component, as shown here.

The adjustment device 60 also has an actuator 62. The actuator 62 can also be formed by an annular component. It is conceivable that the actuator 62 is also formed from a flat component, e.g., made from a sheet metal blank or a plastic part.

As shown in the diagram in FIG. 3, the inside diameters 61.6, 62.6. of the bearing unit 61 and of the actuator 62 form an opening cross-section. This opening cross-section is preferably dimensioned such that it is equal to the maximum opening cross-section Ömax of the gas intake manifold 43 in the area of the adjoining flow guide 51 of the housing part 50 or the adjoining wall 43.1 downstream of the adjustment device 60. In this way, in the operating position shown in FIG. 3, the adjustment device 60 does not constitute any obstruction of the flow in the gas intake manifold 43. However, it is also conceivable that the bearing unit 61 and/or the actuator 62 project slightly into the gas intake manifold 43 or are arranged offset radially outwards in relation to the wall 43.1.

The compressor housing 40 has a bag-shaped holder 45. The adjustment device 60 is inserted into this holder 45. The holder 45 is designed such that the bearing unit 61 is radially and axially secured at the compressor housing 40 relative to the axis of the compressor wheel 41 and the actuator 62 can be rotated in the holder 45.

FIG. 3 clearly shows that the compressor housing 40 has a holder into which the housing part 50 is inserted using a centering attachment 52. In that way the housing part 50 is oriented in the correct position relative to the compressor housing 40. Accordingly, the flow guide 51 of the housing part 50 and the part of the gas guide 43 in the compressor housing 40 can also be interaligned.

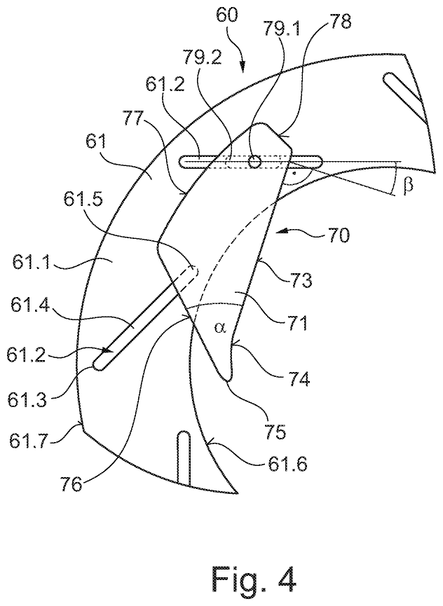

FIG. 4 shows the composition of the bearing unit 61 in more detail. As explained above, the bearing unit 61 can preferably be of annular design. Accordingly, it has a circular outer circumferential boundary 61.7 and an inner diameter 61.6. Other forms of bearing units 61 are of course also conceivable.

The bearing unit 61 has a guide surface 61.1. Slide guides 61.2 can be incorporated in the guide surface 61.1. The slide guides 61.2 are preferably designed as slotted penetrations. As FIG. 4 shows, a large number of slide guides 61.2 are provided—these slide guides 61.2 are evenly distributed around the circumference of bearing unit 61.

The slide guides 61.2 define a linear guide area 61.4. This linear guide area 61.4 can be tangential to the inner diameter 61.6, as shown in FIG. 4.

End areas 61.3, 61.5 can be used to terminate he slide guides 61.2 at the latter's longitudinal ends. This results in a stable geometry for the annular bearing unit 61. The bearing unit 61 has a flat surface facing the flat guide surface 61.1 that also extends annularly and is used for a flat contact with an associated surface area of the housing part 50.

The bearing part 61 is used to house a variety of orifice elements 70 in an adjustable manner. The orifice elements 70 can preferably all be of identical design. It is also conceivable, however, that the design of orifice elements 70 varies individually. However, for identical orifice elements 70, the parts and assembly costs are lower. In this exemplary embodiment, eight orifice elements are installed in the bearing unit 61. It is conceivable, however, that a different number of orifice elements 70 is installed in an adjustment device 60.

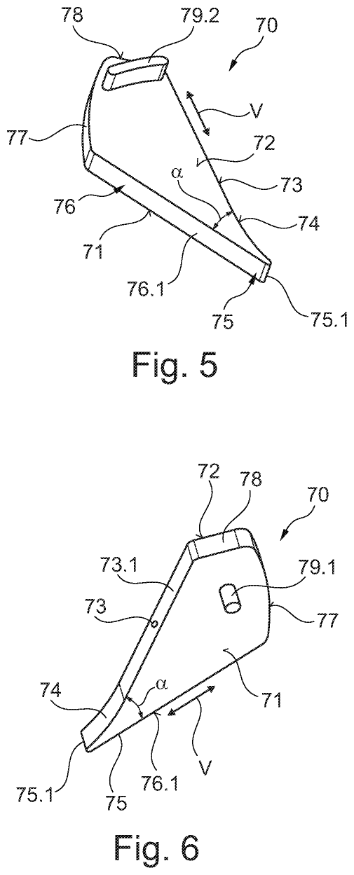

FIGS. 5 and 6 show the design of the orifice elements 70 in more detail. As these drawings show, the orifice element 70 has a slideway 71 on one side of the element. A further slideway 72 can be provided on the opposite side of the element of the orifice element 70. The slideways 71 and 72 can preferably be parallel to each other

The orifice element 70 can have a guide element 79.1, 79.2 in the area of the two slideways 71, 72.

The guide element 79.2 protrudes from the slideway 72. The guide element 79.2 has a rib-shaped design. The width of the guide element 79.2 has been dimensioned to fit into the slot-shaped guide area 61.4.

A conceivable design variant for realizing the invention may also be such that instead of the ribbed guide element 79.2, two projections, for instance cylindrical projections, disposed at a distance from each other are used, which engage with the guide area 61.4.

According to the invention, it is particularly preferably provided that the assignment of the orifice element 70 to the bearing unit 61 is designed such that the guide element 79.2 can be used to adjust the orifice element 70 linearly, but not rotatably, relative to the bearing unit 61 in the guide area 61.4.

The guide element 79.1 protrudes from the slideway 71. In this exemplary embodiment, the guide element 79.1 is designed as a cylindrical bevel. Other designs of the guide element 79.1 are conceivable.

As FIGS. 5 and 6 show further, the orifice element 70 has a first adjustment range 73. This first adjustment range 73 forms a sealing segment 73.1. A boundary area 74 is provided directly downstream of the sealing segment 73.1.

The boundary area 74 can preferably be concave. However, it is also conceivable that the boundary area 73 is connected to the gasket segments 63.1 rectilinearly or in some other way.

The sealing segment 73.1 can, in particular, be designed as a rectilinear surface segment 73.1. Preferably the sealing segment 73.1 is perpendicular to the slideway 71 and/or the slideway 72. The boundary area 74 can, for instance, preferably directly tangentially adjoin the sealing segment 73.1. It is also conceivable for the boundary area 74 to indirectly adjoin the sealing segment 73.1 via an intermediate segment.

The orifice element 70 has an end segment 75. In one embodiment of the invention, this end segment 75 can form a counterstop 75.1 at its free end, as will be explained later.

The end segment 75 can form the transition between the boundary area 74 and a further sealing segment 76.1. The further sealing segment 76.1 is part of a second adjustment range 76 of the orifice element.

The further sealing segment 76.1 is preferably designed as a linearly extending surface area. This sealing segment 76.1 is further preferably aligned perpendicular to the slideway 71 and/or the slideway 72.

The drawings of FIGS. 5 and 6 show that the two sealing segments 73.1 and 76.1 form an angle α. The angle α in this exemplary embodiment is 45°. The angle α is calculated as follows: 360° divided by X, wherein X represents the number of orifice elements 70 of the adjustment device 60.

As FIGS. 5 and 6 further show, an end segment 78 can adjoin the first adjustment range 73. The end segment 78 transitions into an edge 77 and this in turn transitions into the second adjustment range 76.

The orifice elements 70 can preferably be designed as plastic injection molded parts. The guide elements 79.1, 79.2 are preferably integrally molded. It is also conceivable that the orifice elements 70 are manufactured as punched and bent parts from a sheet metal blank. In that case, the guide elements 79.1, 79.2 can be pressed into the orifice element, for instance.

As FIG. 4 shows, the orifice elements 70 can be inserted into the slide guide 61.2, wherein the guide element 79.2 protrudes from the slideway 72. In this way, the orifice elements in the slide guide 61.2 can be adjusted linearly along the longitudinal extension of the guide area 61.4.

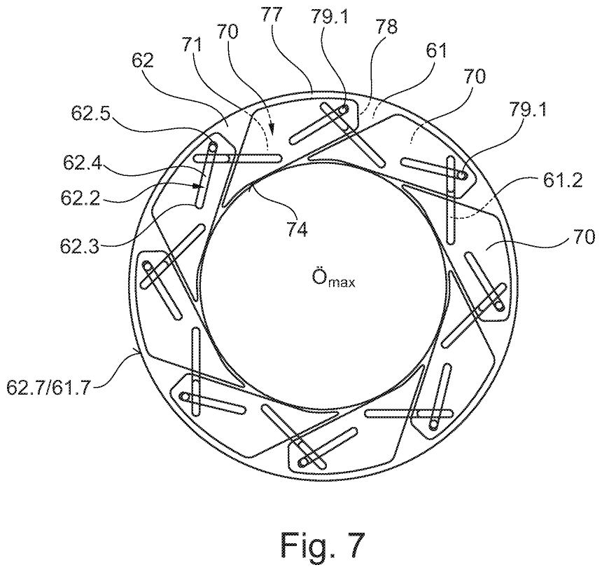

As FIG. 7 shows, the preferably identical orifice elements 70 can be installed in conjunction with the bearing ring 61. The illustration in FIG. 7 is chosen to show the actuator 62 in addition to bearing unit 61. The actuator 62 is drawn transparently, rendering the arrangement of the orifice elements 70 visible.

As FIG. 7 shows, the actuator 62 has an annular geometry. Correspondingly, the actuator 62 has an inner diameter 62.6 and a circular outer circumferential boundary 62.7. This design is preferred. However, provision may also be made that the circumferential boundary 62.7 is not annular but has a different shape.

The actuator 62 forms a guide surface 62.1, which is assigned to the orifice elements 70 when the adjustment device 60 is installed. This guide surface 62.1 faces the slideways 71 of the orifice elements 70. Accordingly, the slideways 71 of the orifice elements 70 can rest against the guide surface 62.1. Slide guides 62.2 are incorporated in the actuator 62. The slide guides 62.2 can be designed as slotted openings, which are excluded from the actuator 62. The slide guides 62.2 have a linear guide area 62.4. For reasons of stability, the end ranges 62.3, 62.5 of the actuator 62 can be connected to this linear guide area 62.4.

For the installation of the adjustment device 60, the actuator 62 is placed on the orifice elements 70. The guide elements 79.1 of the orifice elements 70 each engage in one guide area 62.4 of the slide guides 62.2.

When the adjustment device 60 is installed, the bearing unit 61 is blocked against rotation in the compressor. The actuator 62 can be rotated in the peripheral direction. For this purpose, for instance, an actuating device (not shown) may be used, which acts on the actuator 62 to be able to rotate it in the peripheral direction.

FIG. 7 shows the maximum opening cross-section of the adjustment device 60. Accordingly, the orifice elements 70 are adjusted such that they are held between the actuator 62 and the bearing unit 61. Accordingly, the orifice elements 70 do not protrude beyond the inner diameter 61.6 of the bearing unit 61 or the inner diameter 62.6 of the actuator 62. For this purpose, the flanks 77 of the orifice elements 70 are designed such that they do not protrude beyond the circumferential boundaries 61.7, 62.7. In the open position the orifice elements 70 are arranged in such a way that the sealing segments 73.1 and the boundary areas 74 are almost flush with the inner diameters 61.6, 62.6 of the bearing unit 61 and the actuator 62, and thus with the opening cross-section Ömax of the gas intake manifold 43 in the area of the adjoining flow guide 51 of the housing part 50 or the adjoining wall 43.1 downstream of the adjustment device 60.

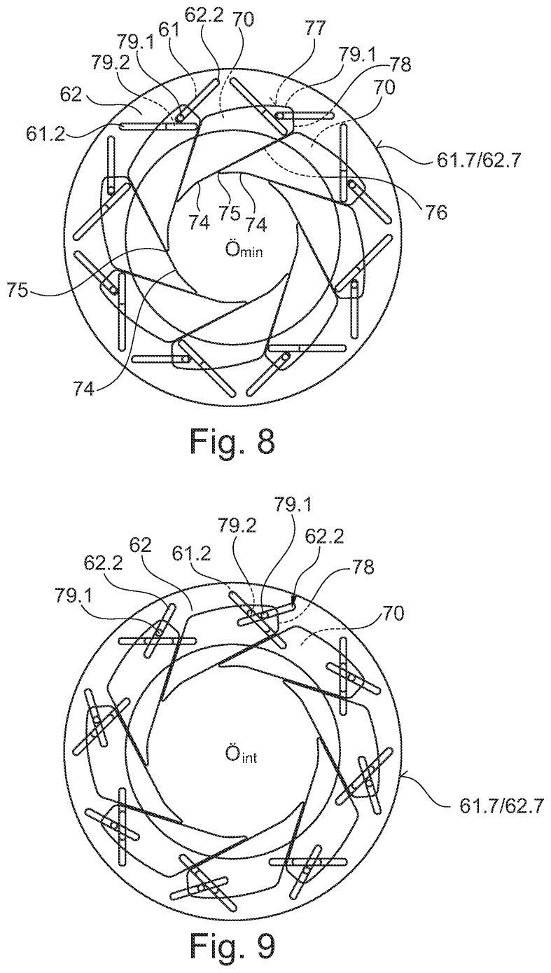

In FIG. 7, if the actuator 62 is turned clockwise in relation to the bearing unit 61, the actuator 62 uses the slide guides 62.2 to drive the guide elements 79.1 of the orifice elements 70. Accordingly, the guide elements 79.1 in the slide guides 62.2 are adjusted linearly. Because the orifice elements 70 are now also moved captive in conjunction with the second guide element 79.2 in the slide guide 61.2 of the bearing unit 61, the orifice elements 70 are adjusted linearly in the direction of the linear guide area 61.4. In this way the orifice elements 70 can be moved linearly from the open position as shown in FIG. 7 to the closed position as shown in FIG. 8.

FIG. 8 shows that in the closed position of the orifice elements 70, the concave boundary areas 74 of the individual orifice elements 70 are interaligned such that a minimum opening cross-section Ömin results, which is approximately circular.

In the closed position as shown in FIG. 8, the sealing segments 73.1 of the orifice elements 70 rest against the sealing segments 76.1 of the adjacent orifice elements 70. In this way, the slideways 71 and/or the slideways 72 of the orifice elements 70 contribute to a closed orifice surface in the closed position, which only opens the minimum opening cross-section Ömin.

According to the invention, it is now provided that, starting from the closed position, in which the sealing segments 73.1, 76.1 are in contact, the orifice elements 70 can be continuously adjusted to the open position (see FIG. 7). To this end, provision is made that starting from the closed position, when the actuator 62 is turned (counterclockwise in FIG. 8), the sealing segments 73.1, 76.2 of the adjacent orifice elements 70 are slightly spaced apart so as not to impede the motion of the orifice elements 70 into the open position. Preferably, in any position between the closed position and the open position, the sealing segments 73.1, 76.1 are aligned in parallel to each other. Especially preferably, the first linear sealing segment 73.1 of the orifice element 70 is set at an angle of 90°+β to the direction of motion of orifice element 70. This angle β is smaller than 0.5*X, wherein: “X=360°/(number of orifice elements (70))”. In this case X=45°. Therefore, β has to be selected smaller than 22.5°.

In this exemplary embodiment α=X. Thus, the angle α between the two linear sealing segments 73.1, 76.1 of the orifice element 70 also has to be selected smaller than β (in this case therefore smaller than 22.5°).

Furthermore, it may preferably be according to the invention that:

“(0.5*X−β)<10°, preferably smaller than 5°, especially preferred smaller than 2°”, applies.

In this exemplary embodiment “(0.5*45°−β)<2°”, i.e., β is >20.5°.

When dimensioning, it is particularly important to select β<0.5 α or β<0.5 X. In this exemplary embodiment, this limit would be chosen accordingly as β<0.5 X, i.e., β<22.5°.

The above-mentioned angular ratios ensure that the sealing segments 73.1, 76.1 lift off from each other immediately after turning the actuator 62 from the closed position.

If the orifice elements 70 are adjusted further, the sealing segments 73.1, 76.1 remain in parallel to each other in every intermediate position and are only slightly spaced apart from each other. This ensures a particularly good sealing effect of the orifice area even in the intermediate position.

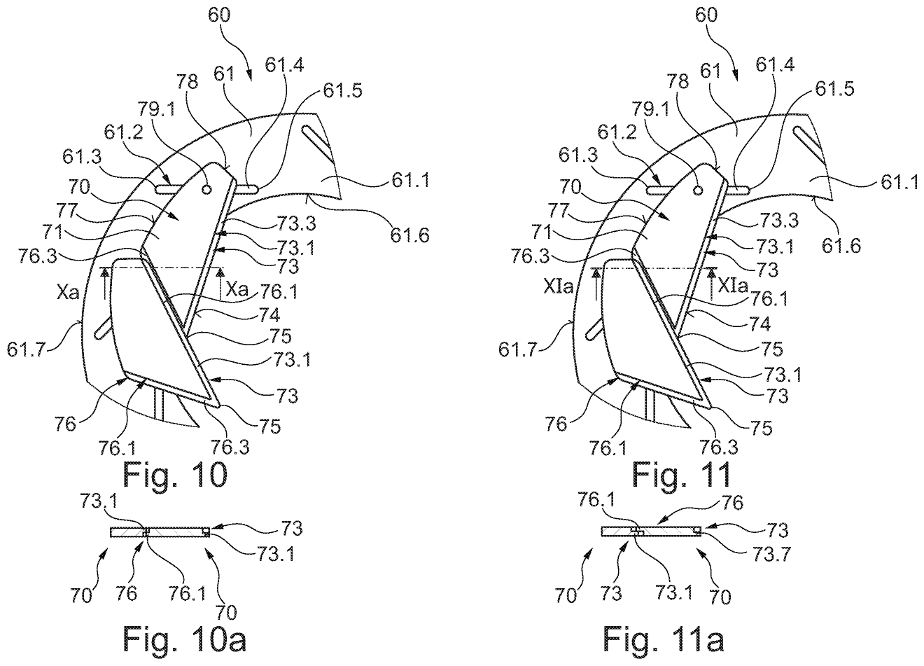

FIG. 10 shows a further design variant of the invention. Identical reference numerals refer to identical component areas. To avoid repetition, reference can be made to the explanations above. Only the changes made to the alternative embodiment shall be explained below.

As FIG. 10 shows, the orifice elements 70 have overlap segments 73.3, 76.3 both in the first adjustment range 73 and in the second adjustment range 76. The overlap segments 73.3, 76.3 are formed as steps. The adjacent orifice elements 70 also have overlap segments 73.1, 76.1, which are stepped to match.

FIG. 10 shows that the overlap segments 73.3, 76.3 of adjacent orifice elements 70 overlap. The assignment is made in such a way that the projections of the overlap segments 73.3, 76.3 overlap in the direction of flow in the gas intake manifold 43, i.e., in the direction of the axis of rotation of the compressor wheel 41. Thus, the overlap segments 73.3, 76.3 of the adjacent orifice elements form 70 labyrinth-like seals, which form a flow resistance in the area of the orifice surface. This flow resistance prevents or reduces the risk of unintentional air flow through the gap areas between the adjacent sealing segments 73.1, 76.2.

FIG. 10a shows a sectional view along the section line Xa-Xa marked in FIG. 10. As this illustration shows, the steps of the orifice element 70, which form the sealing segments 73.1 and 76.1, are each oriented towards one side of the orifice element 70. The sealing segments 73.1, 76.1 of the orifice element 70 at the right in FIG. 10a are located at the rear end. Accordingly, the sealing segments 73.1, 76.1 of the left-hand orifice element 70 are arranged at the front end.

FIG. 10 shows an intermediate position between the closed position and the open position. As can be seen from this diagram, in this position the sealing segments 73.1, 76.1 are arranged in parallel to each other, resulting in only a narrow gap area. This gap area is covered by the overlap segment 73.3, 76.3.

FIGS. 11 and 11a show a further development of the design variant according to FIGS. 10 and 10a. In contrast to the design variant according to FIGS. 10/10a, in the design according to FIGS. 11/11a, the sealing segments 73.1, 76.1 of each orifice element 70 are arranged alternating at the front end and the rear end of the orifice element 70. This is clearly shown in FIG. 11a. In this way, all orifice elements can be designed identically.

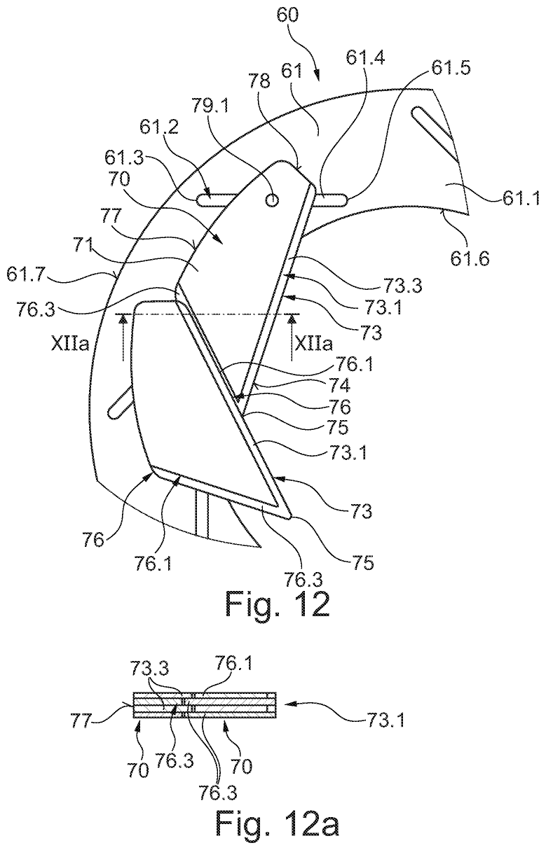

FIGS. 12 and 12a show a further design variant of the invention. This design variant generally matches the design of the adjustment device 61 as shown in the preceding FIGS. 10 to 11a. Therefore, only the differences will be discussed below. In the invention variant according to FIGS. 12 and 12a, the orifice elements 70 have several overlap segments 73.3, 76.3 at their sealing segments 73.1, 76.1. In this case, two protruding overlap segments 73.3, 76.3 are provided at each of the sealing segments 73.1 and 76.1 of an orifice element 70. FIG. 11 then shows that when using identical orifice elements 70, the adjacent sealing segments 73.1, 76.1 of two orifice elements 70 interlock in a comb-like manner, wherein the projections of the overlap segments 73.3, 76.3 overlap in the direction of the axis of rotation of the compressor wheel 41 to form a labyrinth seal.

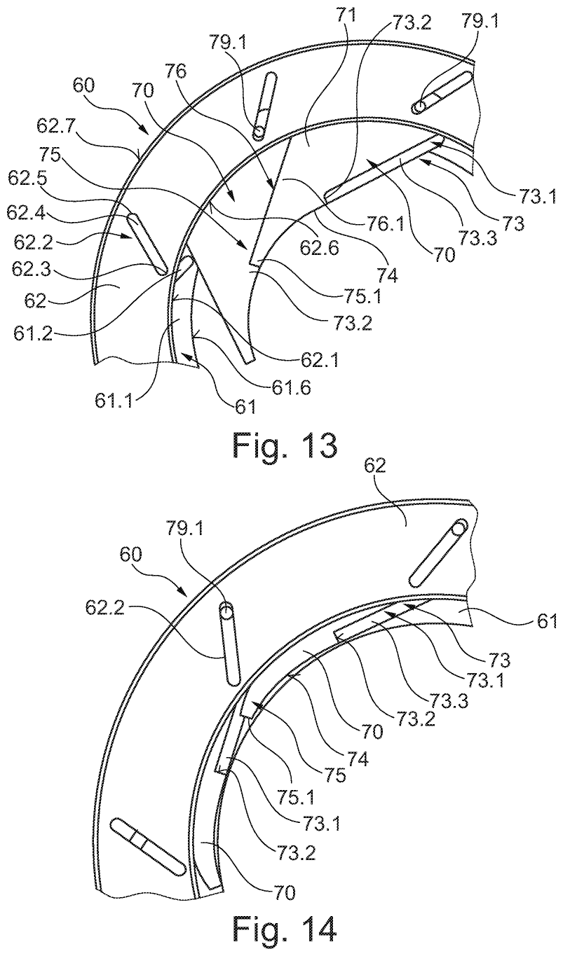

FIGS. 13 and 14 show a further development of the design of the invention as shown in FIGS. 4 to 9. To avoid repetition, reference is made to the explanations above. Only the differences shall be explained below.

Whereas in the embodiment shown in FIGS. 4 to 9 in the closed position of the orifice elements 70, the travel of the orifice elements 70 is limited either by the guide elements 79.1, 79.2, which stop at the associated end areas 62.3, 61.5 of the slide guides 62, 61, or by the sealing segments 73.1, 76.1 of two adjacent orifice elements coming into contact, the orifice elements 70 as shown in FIG. 13 have stops 73.2 and matching counterstops 75.1. In the closed position, the stops 75.1 of the orifice elements 70 abut the associated counterstops 75.1 of the adjacent orifice elements 70 to delimit the closing motion of the orifice elements 70.

As FIGS. 13 and 14 show, the stops 73.2 can preferably be formed in the transition area between the sealing segments 73.1 and the boundary areas 74. The counterstop 75.1 can then be formed by the end segment 75, for instance.

As FIGS. 13 and 14 show, the orifice elements 70 can be equipped with overlap segments 73.3.

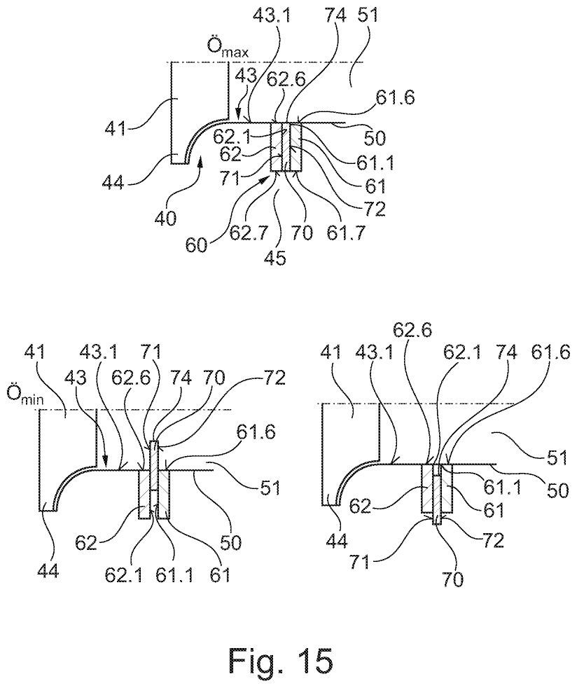

FIG. 15 shows as various operating states of the adjustment device 60 an invention variant. Longitudinal sections through the compressor when the orifice elements 70 in the open position (maximum opening cross-section Ömax) according to FIG. 7, in the closed position (minimum opening cross-section Ömin) according to FIG. 8 or in a retracted position are shown schematically.

In the retracted position, the orifice elements 70 are moved such that their opening cross-section is larger than the opening cross-section Ömax of the open position. In this way the sealing segments 73.1 and the boundary areas 74 of the orifice elements 70 in conjunction with the guide surfaces 61.1, 62.1 of the bearing unit 61 and the actuator 62 form a circumferential groove in the flow guide 51. The circumferential groove acts as a Helmholtz resonator, and can thus be used to cancel out certain frequencies of the compressor. In principle, the orifice elements 70 can be continuously moved between the neutral (Ömax) and the retracted position and thus to adjust the Helmholtz resonator to the frequency to be canceled.

It goes without saying that the shape of the groove can be designed by designing the guide surfaces 61.1, 62.1 of the bearing unit 61 and the actuator 62 in the transition area to the wall 43.1 and to the flow guide 51 according to the measures known from the state of the art.

The invention is not limited to the exemplary embodiment described. Rather, provision may also be made in the invention in that the compressor is used as a support for an exhaust gas turbocharger or is arranged decoupled from an exhaust gas turbocharger. It is also conceivable that the compressor is an electrically driven compressor, wherein the compressor wheel is driven by an electric motor. Such an electrically driven compressor can also be part of a turbocharger for a combustion engine. Furthermore, provision may also be made that the compressor according to the invention is used, for instance, in connection with an air supply for a fuel cell. In this case, the compressor wheel 41 can also be driven by an electric motor.

1-16. (canceled)

17: A compressor for compressing a gaseous fluid, comprising:
a compressor housing;
a compressor wheel rotatably arranged in the compressor housing;
the compressor housing including a gas intake duct configured to feed gas to the compressor wheel, and the compressor housing including a compressor duct configured to discharge compressed gas from the compressor wheel; and
an adjustment device including:
a plurality of orifice elements adjustable between a closed position and an open position to change an opening cross-section of the gas intake duct to form a minimum opening cross-section in the closed position and a maximum opening cross-section in the open position; and
wherein each two adjacent orifice elements include respective sealing segments facing each other in the closed position; and
wherein the orifice elements are further adjustable into a retracted operating position such that in at least some areas the orifice elements delimit a recess in the gas intake duct forming a resonator.

18: The compressor of claim 17, wherein:
the respective sealing segments of the adjacent orifice elements rest against each other in the closed position.

19: The compressor of claim 17, wherein:
the recess comprises a circumferential groove in the gas intake duct.

20: The compressor of claim 17, wherein:
the resonator comprises a Helmholtz resonator.

21: The compressor of claim 17, wherein:
the orifice elements are adjustable between a plurality of retracted operating positions.

22: The compressor of claim 21, wherein:
the orifice elements are continuously adjustable between the plurality of retracted operating positions.

23: The compressor of claim 17, wherein:
the orifice elements are arranged at a distance from each other in the open position.

24: The compressor of claim 17, wherein:
the orifice elements are arranged at a distance from each other in an intermediate position between the open position and the closed position.

25: The compressor of claim 17, wherein:
the respective sealing segments of adjacent orifice elements are parallel to each other during adjustment travel between the open position and the closed position.

26: The compressor of claim 17, wherein:
each orifice element includes two linearly extending sealing segments arranged at an acute angle from each other, wherein in the closed position one of the two sealing segments rests against one of the sealing segments of a first adjacent orifice element and the other of the two sealing segments rests against one of the sealing segments of a second adjacent orifice element.

27: The compressor of claim 17, wherein:
each orifice element includes two linearly extending sealing segments arranged at an acute angle (α) from each other, and a first one of the linear sealing elements is set perpendicular to a direction arranged at an angle (β) from a direction of motion of the orifice element, and the angle (β) is smaller than 0.5 times X, wherein: “X=360°/number of orifice elements”.

28: The compressor of claim 27, wherein:
a difference between 0.5 times X and the angle (β) is less than 10°.

29: The compressor of claim 27, wherein:
a difference between 0.5 times X and the angle (β) is less than 5°.

30: The compressor of claim 27, wherein:
a difference between 0.5 times X and the angle (β) is less than 2°.

31: The compressor of claim 17, wherein:
each orifice element includes two linearly extending sealing segments arranged at an acute angle (α) from each other, and a first one of the linear sealing elements is set perpendicular to a direction arranged at an angle (β) from the direction of motion of the orifice element, and the angle (β) is smaller than 0.5 times X, wherein X corresponds to the angle (α) formed by the two linear sealing segments of the orifice element.

32: The compressor of claim 31, wherein:
a difference between 0.5 times X and the angle (β) is less than 10°.

33: The compressor of claim 31, wherein:
a difference between 0.5 times X and the angle (β) is less than 5°.

34: The compressor of claim 31, wherein:
a difference between 0.5 times X and the angle (β) is less than 2°.

35: The compressor of claim 17, wherein:
as the orifice elements move between the open position and the closed position the respective sealing segments of each two adjacent orifice elements are not more than 1 mm apart.

36: The compressor of claim 17, wherein:
as the orifice elements move between the open position and the closed position the respective sealing segments of each two adjacent orifice elements are not more than 0.3 mm apart.

37: The compressor of claim 17, wherein:
at least one orifice element of two adjacent orifice elements includes an overlap segment adjacent at least one of its sealing segments, and the overlap segment projects to at least partially cover, in a direction of an axis of rotation of the compressor wheel, one of the sealing segments of the adjacent orifice element in the closed position and in at least one intermediate position between the open position and the closed position.

38: The compressor of claim 37, wherein:
the at least one orifice element includes first and second linearly extending sealing segments arranged at an acute angle (α) from each other and the at least one orifice element includes first and second overlap segments adjacent its first and second sealing segments, respectively; and
the first overlap segment overlaps a first adjacent orifice element in the front in the direction of the axis of rotation of the compressor wheel, and the second overlap segment overlaps a second adjacent orifice element in the rear in the direction of the axis of rotation of the compressor wheel.

39: The compressor of claim 38, wherein:
each of the orifice elements is identical to the other orifice elements.

40: The compressor of claim 37, wherein:
at least two adjacent orifice elements include the overlapping segments at least partially overlapping each other in the direction of the axis of rotation of the compressor wheel.

41: The compressor of claim 40, wherein:
the overlapping segments of the at least two adjacent orifice elements are configured to seal against each other in the closed position.

42: The compressor of claim 41, wherein:
the overlapping segments are each configured as a seal attachment that can be bent relative to a base body of a respective orifice element.

43: The compressor of claim 41, wherein:
the overlapping segments are each offset relative to each other such that each overlap segment is in sealing contact with an adjacent orifice element.

44: The compressor of claim 37, wherein:
the overlap segment of the at least one orifice element is integrally formed on the at least one orifice element.

45: The compressor of claim 17, wherein:
the adjustment device further includes a bearing ring, the bearing ring including a plurality of slide glides, each slide glide including a linear guide area, and the bearing ring including a plurality of guide surfaces; and
each of the orifice elements includes a guide element movably received in the linear guide area of one of the slide glides, and each of the orifice elements includes a slideway supported on one of the guide surfaces.

46: The compressor of claim 45, wherein:
the adjustment device further includes an actuator, the actuator including a plurality of actuator slide glides, each actuator slide glide including a linear guide area, each of the orifice elements including a second guide element movably received in the linear guide area of one of the actuator slide glides, such that rotation of the actuator relative to the bearing ring moves the orifice elements between the open position and the closed position.

47: The compressor of claim 17, wherein:
the orifice elements each include a concave delimiting element adjoining the sealing elements, and the delimiting elements form an at least approximately circular orifice opening in the closed position of the orifice elements.

48: The compressor of claim 17, wherein:
movement of the orifice elements from the open position to the closed position is limited by a stop on each orifice element resting in the closed position against a counterstop of an adjacent orifice element.
